(19) United States
(12) Patent Application Publication
(10) Pub. No.: US 2012/0121786 A1
(43) Pub. Date: May 17, 2012

(54) SHORTENING COMPOSITIONS AND METHODS OF MAKING AND USING THE SAME

(76) Inventors: Neil W. Higgins, Bourbonnais, IL (US); Roger L. Daniels, Manhattan, IL (US)

(21) Appl. No.: 13/295,015

(22) Filed: Nov. 11, 2011

Related U.S. Application Data
(63) Continuation-in-part of application No. 12/780,769, filed on May 14, 2010.
Application No. 12/780,769 is a continuation-in-part of application No. PCT/US2011/036375, filed on May 31, 2011.

(51) Int. Cl. A23D 9/007; A23D 9/04; A21D 13/08; A23D 9/00; A23L 1/18

(52) U.S. Cl. 426/556; 426/606; 426/625; 426/549

(57) ABSTRACT

Described herein are shortening compositions having reduced levels of saturated and trans fats. The compositions comprise cellulose fibers, a hard fat and a liquid oil. Also provided are methods of preparing such compositions and use thereof.

### PRIORITY CLAIM

This application is a continuation-in-part of and claims priority to U.S. application Ser. No. 12/780,769 filed May 14, 2010 to Higgins et al., U.S. application Ser. No. 13/072,599 filed Mar. 25, 2011 and International Application No. PCT/US2011/036375 filed May 13, 2011. The disclosures of the above referenced applications are incorporated by reference in their entireties.

### FIELD

Provided herein are shortening compositions having reduced levels of saturated and trans fats. The compositions comprise cellulose fibers, a hard fat and a liquid oil. Also provided are methods of preparing such compositions and uses thereof.

### BACKGROUND

Shortenings are generally produced by appropriate thermal and mechanical treatment of a mixture of several components. In the production of a conventional plastic shortening, lightly hydrogenated vegetable oils and intermediate hardened oils are blended with fully hydrogenated hardstock in varying proportions to produce a product which is about 77% liquid oil, in certain shortening compositions, such as VREAM RighT®, the amount of oil is about 85% oil and the amount of solid is 15% at room temperature. The quality and texture of shortenings depend on incorporated gas, plasticity and consistency, and solid to liquid ratio. These physical characteristics are determined by the crystal phase of the fats used and the method of preparation.

In general, the method of attaining the beta prime crystal form desired for plastic shortenings is to use a suitable beta prime tending highly hydrogenated or saturated hardstock. Conventional beta prime tending hardstocks contain triglycerides that may undergo polymorphic transformations and crystal size changes on processing and storage and/or on temperature variations under stress conditions. This transformation results in a shortening which has a poor appearance, poor volume and poor performance. Further, the hydrogenation process causes transisomeric forms of the mono and polyunsaturates to form.

It has been suggested in the literature that the consumption of trans fatty acids and saturated fatty acids can increase the amount of LDL cholesterol in the body, and that consumption of trans fatty acids also can reduce HDL cholesterol levels. There have been various shortening compositions proposed in an attempt to reduce the trans fatty acids and saturated fatty acid content in shortenings. Exemplary compositions are described in US Patent Publication No. 2005/0271790, U.S. Pat. Nos. 5,106,644; 6,033,703; 5,470,598; 4,156021 and 6,461,661. Among various shortening formulations available, VREAM® formulated using partially hydrogenated oil and a heavily hydrogenated oil contains the total amount of trans plus saturated fatty acids is about 50%, VREAM®NH formulated without use of hydrogenation contains the total amount of trans plus saturated fatty acids is about 52%, and VREAM RighT® formed by using a hydrogenated base stock and a fully hydrogenated oil contains the total amount of trans plus saturated fatty acids is about 32%.

There is a continuing need for shortenings having reduced levels of saturated fats and trans fats, and acceptable physical properties for handling and food preparation.

### SUMMARY

In certain embodiments, provided herein are shortening compositions comprising a cellulose fiber, a hard fat and a liquid oil. In certain embodiments, the use of cellulose fibers allows a plastic shortening like material to be produced with reduced levels of both trans fatty acids and saturated fatty acids compared to a shortening compositions without the fibers.

The cellulose fibers are used in the compositions provided herein without hydrating with water, or treatment with other additives such as gums or emulsifiers. In certain embodiments, a shortening composition provided herein comprises less than about 1% water by weight based on total weight of the composition. In certain embodiments, the shortening composition provided herein comprises less than about 0.1%, 0.3%, 0.5%, 0.7%, 1%, 1.5%, 2%, 2.5%, or 3% water by weight based on total weight of the composition. The cellulose fibers having a range of average lengths, processed from different source materials and of different levels of purity can be used.

In certain embodiments, the hard fat used herein comprises fully or partially hydrogenated oil(s), solid stearin fractions, partial esters such as diglycerides and monoglycerides, waxes or mixtures thereof. In certain embodiments, the liquid oil used herein comprises canola, high oleic canola, soybean, corn, sunflower, rapeseed, peanut, safflower, olive, cottonseed, or a mixture thereof.

In another embodiment, provided herein is a method for preparing the shortening compositions described herein. In certain embodiments, the method of preparation comprises the step of providing a composition comprising a cellulose fiber, a hard fat and a liquid oil, and mixing the composition to provide a shortening composition. During the mixing step, the composition is brought to a molten state such that the admixture becomes homogenized. The order of adding the ingredients and heating the ingredients can be changed as required by a particular process. The molten homogeneous composition then is cooled, in one embodiment, with agitation, to promote a crystal structure that imparts the desired physical properties to the shortening. A heat exchanger, in one embodiment, a scraped surface heat exchanger, can provide the desired cooling with agitation.

In certain embodiments, the shortenings so produced have lower levels of saturated fats and trans fats than the shortenings known in the art. In certain embodiment, the shortening compositions provided herein are used in bakery products, e.g., cookies, cakes, pie crusts, breads and other products in place of conventional partially hydrogenated shortenings.

It is to be understood that both the foregoing general description and the following detailed description are exemplary and explanatory only and are not restrictive.

### DETAILED DESCRIPTION

Provided herein are shortening compositions comprising a cellulose fiber, a hard fat to provide a crystal matrix and a liquid oil. Further provided are methods of making the compositions and uses of the compositions. The methods and compositions are described in detail in the sections below.

Definitions

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The term “plastic” as used herein is utilized to designate a shortening composition which is solid at room temperature.

The term “fat” as used herein is intended to include all edible, fatty acid triglycerides regardless of origin or whether they are solid or liquid at room temperature. Thus, the term “fat” includes normally liquid and normally solid vegetable and animal fats and oils.

The term “hard fat” or “hydrogenated fat” as used herein refers to fully or partially hydrogenated oil(s), solid stearin fractions, partial esters such as diglycerides and monoglycerides, waxes or mixtures thereof.

The term “oil” as employed herein, is intended to refer to those fats which are liquid in their unmodified state. Natural and synthetic fats and oils are included in these terms.

The term “edible oil”, “base oil” or “liquid oil” as used herein refers to an oil which is substantially liquid at room temperature. The base oil or liquid oil can be unhydrogenated oil or partially hydrogenated oil, modified oil or mixtures thereof.

As used herein, ‘cellulose fiber” refers to a fibrous cellulose material obtained from plant sources. The fibrous nature of the material and the existence of capillaries that can take up oil is an important feature for the cellulose fiber used herein. Exemplary cellulose fibers are obtained from wood pulp, pea and bamboo.

It must be noted that, as used in the specification and the appended claims, the singular forms “a,” “an” and “the” include plural referents unless the context clearly dictates otherwise. Thus, for example, reference to “a vegetable oil” includes mixtures of two or more such vegetable oils, and the like. In one embodiment, reference to “a vegetable oil” includes interesterified and/or genetically modified oils.

All percent values are given as weight percent unless expressly stated otherwise.

Compositions

In certain embodiments, provided herein are shortening compositions comprising a cellulose fiber, a hard fat and a liquid oil. The hard fat in the compositions provides a crystal matrix for the composition. Without being bound to any particular theory, it is believed that in certain embodiments, the cellulose fibers aid in structuring the shortening, partly at least by taking some of the oil into capillaries and tying up some oil wetting the fiber surfaces, and partly by physically acting to re-enforce the crystal structure formed by the higher melting fractions incorporated into the composition. In certain embodiments, the use of cellulose fibers allows a plastic shortening to be produced with reduced levels of both trans fatty acids and saturated fatty acids compared to a shortening formulated without the cellulose fibers. In certain embodiments, the use of cellulose fibers allows trans fatty acids plus saturated fat acids level in the shortening composition to be reduced by about 75%, 70%, 65%, 60%, 55%, 50%, 45%, 40%, 35%, 32%, 30%, 25%, 20%, 18%, 15%, 10% or 5% by weight as compared to the shortening compositions known in the art. In certain embodiments, the use of cellulose fibers allows trans fatty acids plus saturated fat acids level in the shortening composition to be reduced by about 25%, 20%, 18%, 15%, 10% or 5% by weight as compared to the shortening compositions VREAM RighT®.

The cellulose fibers are used in the compositions without hydrating with water, or treatment with other additives such as gums or emulsifiers. In certain embodiments, the shortening composition provided herein comprises less than about 0.1%, 0.3%, 0.5%, 0.7% or 1% water by weight based on total weight of the composition. The cellulose fibers having a range of average lengths, processed from different source materials and of different levels of purity can be used. In certain embodiments, the shortening composition provided herein comprises less than about 1% water by weight based on total weight of the composition.

In certain embodiments, the cellulose fibers for use herein are obtained from plant sources, including but not limited to wood pulp, bamboo, pea, citrus fruit and sugar beets. In certain embodiments, the cellulose fibers used herein include, UPTAKE 80, and CENTU-TEX, CeREAFill produced by Norben Company, Inc., CREAFIBE QC 150, and CREACLEAR SC 150 produced by CREAFILL Fibers Corp., and SOLKA FLOC® 900 FCC, SOLKA FLOC® 300 FCC, SOLKA FLOC® 40 FCC, JUSTFIBER®C40FCC produced by International Fiber Corporation and RIDGELAND® Fiber PC-200. In certain embodiments, the cellulose fibers have an average fiber length of about 75-400 micron, 85-400 micron, 100-400 micron, 100-350 micron, or 110-350 micron. In certain embodiments, the cellulose fibers have an average fiber length of about 110-350 micron. In certain embodiments, the cellulose fibers have an average fiber length of about 115, 120 or 300 micron. In certain embodiments, the cellulose fibers are obtained from an algal source. Any cellulose material having fibrous nature and capillaries that can take up oil can be used in the compositions provided herein. Unlike the compositions known in the literature, for example, US publication no. 2005/0271790, the compositions herein do not require a high purity cellulose fiber.

In certain embodiments, the compositions provided herein comprise the cellulose fiber in an amount from about 1 to about 15% by weight based on the total weight of the composition. In certain embodiments, the amount of the cellulose fiber in the compositions is about 1%-10%, about 1%-7%, about 1%-4%, about 2%-10%, about 2%-7%, or about 2-5% by weight based on the total weight of the composition. In certain embodiments, the amount of the cellulose fiber in the compositions is about 3%-5% or about 4%-5% by weight based on the total weight of the composition. In certain embodiments, the amount of the cellulose fiber in the compositions is about 1, 2, 3, 4, 5, 6, 7, 8, 9, 10, 11, 12, 13, 14 or 15% by weight based on the total weight of the composition. In certain embodiments, the amount of the cellulose fiber in the compositions is about 3, 4, 4.5, 5, 6 or 7% by weight based on the total weight of the composition.

The cellulose fibers are used in the compositions without hydrating with water, or treatment with other additives such as gums or emulsifiers. In certain embodiments, a shortening composition provided herein comprises less than about 1% water by weight based on total weight of the composition. In certain embodiments, the shortening composition provided herein comprises less than about 0.1%, 0.3%, 0.5%, 0.7%, 1%, 1.5%, 2%, 2.5%, or 3% water by weight based on total weight of the composition. The cellulose fibers having a range of average lengths, processed from different source materials and of different levels of purity can be used.

In certain embodiments, the hard fat used herein comprises fully or partially hydrogenated oil(s), solid stearin fractions, partial esters such as diglycerides and monoglycerides, waxes or mixtures thereof In certain embodiments, the fully hydrogenated oil is selected from fully hardened fish oil, fully hardened animal oil, fully hardened palm oil, fully hardened high erucic rape seed oil, fully hardened soya oil, fully hardened sun flower oil, fully hardened corn oil, fully hardened peanut oil, fully hardened safflower oil, fully hardened olive oil, fully hardened palm stearin, fully hardened palm olein, derivatives and mixtures thereof In certain embodiments, the partially hydrogenated oil is selected from partly hardened fish oil, partly hardened animal oil, partly hardened palm oil, partly hardened high erucic rape seed oil, partly hardened soya oil, partly hardened sun flower oil, partly hardened corn oil, partly hardened peanut oil, partly hardened safflower oil, partly hardened olive oil, partly hardened palm stearin, partly hardened palm olein, partly hardened cotton seed oil, derivatives and mixtures thereof In certain embodiments, the stearin fraction or the monoglyceride and/or diglyceride can be derived from natural food grade fats, including plant fats, such as coconut oil, palm oil, palm kernel oil, and the like, or fats that have been fully hydrogenated. Thus, in certain embodiments, the stearin fraction or the monoglyceride and/or diglyceride is derived from naturally saturated fats or oils. In certain embodiments, stearin fraction or monoglyceride and/or diglyceride is derived from palm oil.

In certain embodiments, the total amount of hard fat used in the compositions provided herein is from about 5 to about 20% by weight based on the total weight of the composition. In certain embodiments, the total amount of hard fat in the compositions is about 7%-15%, about 7%-13%, about 8%-15%, about 8%-12%, about 8%-11%, or about 9%-11% by weight based on the total weight of the composition. In certain embodiments, the total amount of hard fat in the compositions is about 8%-10% or about 9%-10% by weight based on the total weight of the composition. In certain embodiments, the total amount of hard fat in the compositions is about 5, 6, 7, 8, 9, 10, 10, 11, 12, 13, 14, 15, 16, 17, 18, 19, 20, 21, 22, 23, 24, or 25% by weight based on the total weight of the composition. In certain embodiments, the total amount of hard fat in the compositions is about 9, 9.5, 10, 10.5, 10.75, 11, 11.5, 12, 12.5, or 13% by weight based on the total weight of the composition.

In certain embodiments, the hard fat used herein is selected from palm hard fat, soybean oil hard fat, cotton hard fat, palm stearin, a blend of triglycerides, diglycerides, monoglycerides produced from soybean oil then hydrogenated to saturation, and cotton hard fat.

In certain embodiments, the hard fat used herein comprises a blend of palm hard fat and soybean oil hard fat. In certain embodiments, the amount of palm hard fat in the hard fat blend is about 60-85% by weight based on the total weight of the hard fat in the composition. In certain embodiments, the amount of palm hard fat in the hard fat blend is about 70-80%, 70-85%, 75-80%, 75-85%, or 76-79% by weight based on the total weight of the hard fat in the composition. In certain embodiments, the amount of palm hard fat in the hard fat blend is about 70, 72, 74, 75, 76, 77, 78, 79, 80, 81, 82, 83, 84, or 85% by weight based on the total weight of the hard fat in the composition. In one embodiment, the amount of palm hard fat in the hard fat blend is about 76, 76.5, 77, 77.5, 78, 78.5, 79, 79.5, 80, 80.5, 81, 81.5, 82, 82.5, 83, 83.5, 84, 84.5 or 85% by weight based on the total weight of the hard fat in the composition. In certain embodiments, the amount of soybean oil hard fat in the hard fat blend is about 60-85% by weight based on the total weight of the hard fat in the composition. In certain embodiments, the amount of soybean oil hard fat in the hard fat blend is about 15-35%, 17-32%, 20-30%, or 20-25%, by weight based on the total weight of the hard fat in the composition. In certain embodiments, the amount of soybean oil hard fat in the hard fat blend is about 15, 17, 20, 22, 24, 26, 28, 30, 32, 34, or 35% by weight based on the total weight of the hard fat in the composition. In one embodiment, the amount of soybean oil hard fat in the hard fat blend is about 20, 20.5, 21.5, 22, 22.5, 23, 23.5, 24, 24.5 or 25% by weight based on the total weight of the hard fat in the composition.

In certain embodiments, the hard fat used herein comprises a blend of palm hard fat and soybean oil hard fat. In certain embodiments, the amount of palm hard fat in the hard fat blend is about 6-12% by weight based on the total weight of the composition. In certain embodiments, the amount of palm hard fat in the hard fat blend is about 6-10%, 7-10%, 7-9% or 7-8% by weight based on the total weight of the composition. In certain embodiments, the amount of palm hard fat in the hard fat blend is about 6, 7, 7.2, 7.4, 7.5, 8 or 8.5% by weight based on the total weight of the composition. In certain embodiments, the amount of soybean oil hard fat in the hard fat blend is about 1-5% by weight based on the total weight of the composition. In certain embodiments, the amount of soybean oil hard fat in the hard fat blend is about 1-3 or 2-3%by weight based on the total weight of the composition. In certain embodiments, the amount of soybean oil hard fat in the hard fat blend is about 2, 2.09, 2.2, 2.3, 2.4, 2.5, 2.7, 2.9 or 3% by weight based on the total weight of the composition.

In certain embodiments, the hard fat used herein comprises cotton hard fat. In certain embodiments, the amount of cotton hard fat in the composition is about 7-20% by weight based on the total weight of the composition. In certain embodiments, the amount of cotton hard fat in the composition is about 7-20%, 7-17%, or 9-17% by weight based on the total weight of the composition. In certain embodiments, the amount of cotton hard fat in the composition is about 7, 9, 11, 13, 15, 17, 19 or 20% by weight based on the total weight of the composition.

In certain embodiments, the hard fat used herein comprises soybean oil hard fat. In certain embodiments, the amount of soybean oil hard fat in the composition is about 5-20% by weight based on the total weight of the composition. In certain embodiments, the amount of soybean oil hard fat in the composition is about 7-20%, 7-17%, 9-17%, or 10-15% by weight based on the total weight of the composition. In certain embodiments, the amount of soybean oil hard fat in the composition is about 8, 10, 12, 14, 16, 18 or 20% by weight based on the total weight of the composition.

In certain embodiments, the hard fat used herein comprises palm hard fat. In certain embodiments, the amount of palm hard fat in the composition is about 5-20% by weight based on the total weight of the composition. In certain embodiments, the amount of palm hard fat in the composition is about 7-20%, 7-17%, 9-17%, or 10-15% by weight based on the total weight of the composition. In certain embodiments, the amount of palm hard fat in the composition is about 8, 10, 12, 14, 16, 18 or 20% by weight based on the total weight of the composition.

In certain embodiments, the hard fat used herein comprises palm stearin. In certain embodiments, the amount of palm stearin in the composition is about 15-30% by weight based on the total weight of the composition. In certain embodiments, the amount of palm stearin in the composition is about 15-25%, 17-25%, 20-25%, or 20-30% by weight based on the total weight of the composition. In certain embodiments, the amount of palm stearin in the composition is about 15, 17, 20, 21, 22, 23, 24, 25, 26, 28, or 30% by weight based on the total weight of the composition.

In certain embodiments, the hard fat used herein comprises a blend of triglycerides, diglycerides, and monoglycerides produced from soybean oil then hydrogenated to saturation. In certain embodiments, the amount of the blend from soybean oil in the composition provided herein is about 5-20% by weight based on the total weight of the composition. In certain embodiments, the amount of the blend from soybean oil in the composition is about 7-20%, 7-17%, 9-17%, or 10-15% by weight based on the total weight of the composition. In certain embodiments, the amount of the blend from soybean oil in the composition is about 8, 10, 12, 14, 16, 18 or 20% by weight based on the total weight of the composition.

In certain embodiments, the liquid oil used herein comprises canola, high oleic canola, soybean, corn, sunflower, rapeseed, peanut, safflower, olive, cottonseed, or a mixture thereof. In certain embodiments, the amount of liquid oil in the composition is about 70-90% by weight based on the total weight of the composition. In certain embodiments, the amount of palm stearin in the composition is about 75-90%, 80-90%, 75-85%, or 82-88% by weight based on the total weight of the composition. In certain embodiments, the amount of liquid oil in the composition is about 75, 77, 79, 80, 82, 83, 84, 85, 86, 87, 88, 89, or 90% by weight based on the total weight of the composition. In certain embodiments, the amount of liquid oil in the composition is about 83, 83.5, 84, 84.5, 85, 85.25, 85.5, 86, 86.5, 87, 87.5, 88, 88.5, 89, or 90% by weight based on the total weight of the composition. In certain embodiments, the amount of Canola oil in the composition is about 83, 83.5, 84, 84.2, 84.5, 85, 85.25, 85.5, 86, 86.2, 86.5, 87, 87.5, 88, 88.5, 89, or 90% by weight based on the total weight of the composition.

In certain embodiments, the compositions provided herein further comprise one or more additives. Common additives that can be added to the shortening compositions provided herein include, but are not limited to stabilizers, flavoring agents, emulsifiers, anti-spattering agents, colorants, or antioxidants. Exemplary additives are described, for example, in Campbell et al., Food Fats and Oils, 8th Ed., Institute of Shortening and Edible Oils, Washington, D.C.

In certain embodiments, the shortening formulations further comprise an antioxidant. A wide variety of antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, polymeric antioxidant (Anoxomer) plant (or spice and herb) extracts (i.e. rosemary, sage, oregano, thyme, marjoram, etc.) and mixtures thereof.

In certain embodiments, the shortening formulations further comprise an emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₂ fatty acids.

In certain embodiments, the compositions provided herein comprise 4.5% cellulose fiber, 8.33% palm hard fat, 2.42% soybean hard fat and 84.75% high oleic canola oil by weight based on the total weight of the composition.

In certain embodiments, the compositions provided herein comprise 4.37% cellulose fiber, 8.08% palm hard fat, 2.35% soybean hard fat and 82.21% canola oil by weight based on the total weight of the composition and 3 g monoglyceride DIMODAN® P-T-K-A (kosher approved distilled monoglyceride made from edible, refined palm oil).

In certain embodiments, the compositions provided herein comprise 4.5% cellulose fiber, 8.33% palm hard fat, 2.42% soybean hard fat and 84.75% canola oil by weight based on the total weight of the composition.

In certain embodiments, the compositions provided herein comprise 4.5% cellulose fiber, 7.21% palm hard fat, 2.09% soybean hard fat and 86.20% canola oil by weight based on the total weight of the composition.

In certain embodiments, the compositions provided herein comprise 4.5% cellulose fiber, 7.21% palm hard fat, 2.09% soybean hard fat, 84.20% canola oil, 0.75% distilled monoglyceride from palm oil, 1.15% polyglycerol ester emulsifier, PGE TGMSH-K (manufactured by LONZA, Inc), and 0.10% antioxidant 20 TBHQ by weight based on the total weight of the composition.

In certain embodiments, the shortening formulations further comprise additional ingredients, such as butter flavors, meat or tallow flavors, olive oil flavors and other natural or synthetic flavors. In certain embodiments, vitamins can be included in the compositions provided herein. In certain embodiments, various other additives can be used in the shortenings provided that they are edible and aesthetically desirable.

Methods of Preparation

In certain embodiments, the methods of preparation comprise the steps of providing a composition comprising a cellulose fiber, a hard fat and a liquid oil, and mixing the composition to provide a shortening composition. During mixing step, the composition is brought to a molten state such that admixture becomes homogenized. The order of adding the ingredients and heating the ingredients can be changed as required by a particular process. The ingredients can be added at ambient temperature, or at a higher temperature, depending on the particular system used, and it is intended that the claims appended hereto shall not be limited by the order of the heating and mixing steps. The molten homogeneous composition is cooled, in one embodiment, with agitation, to promote a crystal structure that imparts the desired physical properties to the shortening. A heat exchanger, in one embodiment, a scraped surface heat exchanger, can provide the desired cooling with agitation.

In one embodiment, provided herein is a method for preparing the shortening compositions, wherein the method comprises a) blending together the liquid oil and cellulose fiber to obtain a blend of cellulose fiber and oil, and b) mixing a hard fat in the blend. In certain embodiments, steps a) and b) are carried out at a temperature of about 40-95° C., 50-75° C., 60-75° C. or 60-70° C. In certain embodiments, the mixing step b) is followed by cooling, optionally with agitation, to obtain a solidified shortening. In certain embodiments, no external water is added during preparation of the compositions.

In certain embodiments, a mechanical agitator is used to agitate the blends in steps a) and b). In one embodiment, in step a), the agitation is carried out till the cellulose fiber disperses into the oil. In certain embodiments, step a) is started at room temperature and the oil is heated up to a temperature of about 45, 50, 53, 55, 57, 59, 61, 63, 65, 67, 70, 73 or 75° C. while mixing. In certain embodiments, the hard fat is added to the blend of liquid oil and cellulose fiber at about 50, 53, 55, 57, 59, 61, 63, 65, 67, 70, 73 or 75° C. The complete blend is mixed for an additional time of about 3-15 minutes, or 3-10 minutes and then cooled, optionally with agitation, to solidify.

In another embodiment, the method comprises a) blending together the liquid oil and hard fat, and b) mixing cellulose fiber. In certain embodiments, steps a) and b) are carried out at a temperature of about 40-95° C., 50-75° C., 50-70° C., 60-75° C. or 60-70° C. In certain embodiments, the mixing step b) is followed by cooling, optionally with agitation, to obtain a solidified shortening. In certain embodiments, no external water is added during preparation of the compositions.

The admixing of the cellulose fiber, hard fat and liquid oil can be accomplished using techniques known in the art. In certain embodiments, the admixture can be then subjected to agitation by means of a scraped-surface heat exchanger known in the art of shortening manufacture. In certain embodiments, processing conditions within the scraped-surface heat exchanger can be adjusted to further promote the desired shortening properties. The scraper blades prevent any build-up on the cylinder of crystals and other large particulates that can reduce thermal exchange and increase run time. A number of different operating parameters in the scraped-surface heat exchanger can be modified in order to optimize the one or more properties of the shortening (e.g., hardness, melting). For example, the speed of the scraping blades, the pumping speed through the scraped surface heat exchanger, and the exit temperature from the heat exchanger can be modified to optimize the hardness of the shortening, which is shown in the working examples below.

The shortenings produced herein can be used to produce a variety of foods including, but not limited to, popcorns baked goods, an icing, biscuits, bread, a pie crust, a danish, a croissant, or a pastry puff. With the reduction in total saturated and trans fat content, food products produced with the shortenings described herein can provide health benefits.

In certain embodiments, the shortening compositions provided herein are added in microwave popcorn bags using methods known in the art. In certain embodiments, a microscopic evaluation of samples from popcorn bags demonstrates uniform distribution of salt and shortening in microwave bags.

The following examples present certain exemplary embodiments and are intended by way of illustration and not by way of limitation. In each of the examples herein, percentages indicate weight percent of the total mixture, unless otherwise indicated.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the claimed subject matter. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Examples 1-2

| | Palm Hard | | | |
|---|---|---|---|---|
| | Fat (PHF) | Soyabean Hard | High Oleic Canola | Cellulose fiber |
| | (g) | Fat (SHF) (g) | Oil (HOC) (g) | (FCC 900) (g) |
| Ex. 1 | 38.7 | 25.8 | 511.5 | 24.0 (4%) |
| Ex. 2 | 36.7 | 24.4 | 507.4 | 31.5 (5.25%) |

In Examples 1 and 2, HOC and cellulose fiber were blended together at room temperature using a mechanical agitator at about 500 RPM. The mixing was started at room temperature and the oil was heated while the mixing continued. After 30 minutes, at about 93° C., the hard fat blend (PHF+SFH) was added as flakes of each component. The temperature of the mixture fell to about 81° C. Heating was continued, and after about 9 minutes, temperature was back to about 93° C. The heat was turned down about 30 minutes after adding hard fat. When temperature fell to 85° C., heat was turned off. When temperature fell to 63° C., the mixture was poured into a Cuisinart Frozen Yogurt-ICE cream & Sorbet Maker (model ICE-20) and crystallized. When it appeared grainy like apple sauce and had a consistency similar to soft mash potatoes it was poured and scraped into a 32 oz glass jar and stored.

### Example 3

| | Palm | Soyabean | High Oleic | |
|---|---|---|---|---|
| | Hard Fat | Hard Fat | Canola Oil | Cellulose fiber |
| | (PHF) (g) | (SHF) (g) | (HOC) (g) | (FCC 900) (g) |
| Ex. 3 | 80.6 | 22.5 | 782 | 32 (3.6%) |

The high oleic canola oil and cellulose fiber were blended together in a 2500 ml beaker on a hot plate using a mechanical agitator. The agitation was enough to disperse the cellulose fiber into the oil. The mixing was started at room temperature and the oil was heated while the mixing continued up to a temperature of about 63° C., then the melted hard fat blend was added. After the hard fat addition, the temperature was about 64° C. The complete blend was mixed for an additional 5 minutes then poured into a Cuisinart Frozen Yogurt-ICE cream & Sorbet Maker (model ICE-20) and crystallized. When it appeared grainy like apple sauce and had a consistency similar to soft mash potatoes it was poured and scraped into a 32 oz glass jar and stored in a room held at 70° F.

### Example 4

| | Palm | Soyabean | High Oleic | |
|---|---|---|---|---|
| | Hard Fat | Hard Fat | Canola Oil | Cellulose Fiber |
| | (PHF) (g) | (SHF) (g) | (HOC) (g) | (FCC 900) (g) |
| Ex. 4 | 61.5 | 22.5 | 514.5 | 24 |

The high oleic canola oil and cellulose fiber were blended together in beaker at room temperature and agitation was continued on a hot plate using a mechanical agitator. The agitation was continued for one hour. The melted hard fat blend was added at about 147° F. The complete blend was mixed for an additional 5 minutes then poured into a Cuisinart Frozen Yogurt-ICE cream & Sorbet Maker (model ICE-20) and crystallized. When it appeared grainy like apple sauce and had a consistency similar to soft mash potatoes it was poured and scraped into a 32 oz glass jar and stored in a room held at 70° F.

### Examples 5-33

Examples 5-33 were prepared by the following method: The desired quantity of liquid oil was added in a 2500 mL beaker. The beaker was placed on a hotplate and an agitator was positioned. The agitator was turned on and speed was set at 300 RPM. The hot plate was turned to 200° C. The desired quantity of cellulose was added while mixing for about 20 minutes. When the oil temperature reached 70° C., the desired quantity of hard fat was added and stirring continued. The mixing was continued for about 5 minutes. The heat and agitation were turned off after 5 minutes. The compositions were cooled as described in Examples 1-4.

| | | | | | | Cellulose Fiber (g) | | | | | |
|---|---|---|---|---|---|---|---|---|---|---|---|
| | Hard Fat Blend | | | | | | | | | Uptake | Cera |
| | (PHF 77.5% + SHF | Liquid Oil (g) | | | | FCC | FCC | FCC | Centu-Tex | 80 Pea | Fibe |
| Ex. | 22.5%) (g) | HOC | Canola | Corn | Sunflower | 900 | 40 | 300 | Pea Fiber | Fiber | QC 150 |
| 5 | 107.5 | 852.5 | | | | 40 | | | | | |
| 6 | 107.5 | 852.5 | | | | | 40 | | | | |
| 7 | 107.5 | 842.5 | | | | | | 50 | | | |
| 8 | 107.5 | | 852.5 | | | 40 | | | | | |
| 9 | 107.5 | | | 852.5 | | 40 | | | | | |
| 10 | 107.5 | | | | 852.4 | 40 | | | | | |
| 11 | 105.5 | | 882.44 | | | 10 | | | | | |
| 12 | 107.5 | | 872.55 | | | 20 | | | | | |
| 13 | 107.5 | | 812.52 | | | 80.01 | | | | | |
| 14 | 107.5 | | 792.51 | | | 100.04 | | | | | |
| 15 | 107.5 | | 742.5 | | | 150 (15%) | | | | | |
| 16 | 107.5 | | 892.57 | | | 0 | | | | | |
| 17 | 107.51 | | 887.54 | | | 5 (0.5%) | | | | | |
| 18 | 107.5 | | 852.5 | | | 40 (5%) | | | | | |
| 19 | 50.05 | | 910.02 | | | 40 (5%) | | | | | |
| 20 | 90.01 | | 870.02 | | | 40 (5%) | | | | | |
| 21 | 130 | | 830 | | | 40.01 (5%) | | | | | |
| 22 | 170 | | 790 | | | 40.4 | | | | | |
| 23 | 210 | | 750 | | | 40 | | | | | |
| 24 | 250 | | 710 | | | 40 | | | | | |
| 25 | 90.01 | | 870.02 | | | 40.15 | | | | | |
| 26 | 107.5 | | 807.5 | | | 85.6 | | | | | |
| 27 | 112.58 | | 812.52 | | | 75.4 | | | | | |
| 28 | 107.5 | | 852.53 | | | | | | 40.1 | | |
| 29 | 107.5 | | 852.6 | | | | | | | 40.15 | |
| 30 | 107.5 | | 852.49 | | | | | | | | 40.08 |
| 31 | 107.5 | | 852.5 | | | | | | | | 40.03 |
| 32* | 107.5 | | 852.51 | | | 40.01 | | | | | |
| 33 | 107.58 | | 852.5 | | | 40.16 | | | | | |

*Example 32 was prepared formulating hard fat and liquid oil before adding cellulose fiber.

### Examples 34-35

In Examples 34-35, cotton hard fat was used and the compositions were prepared by method described in Examples 5-33.

| | Cotton Hard | Canola | Cellulose Fiber |
|---|---|---|---|
| | Fat (g) | Oil (g) | (FCC 900) (g) |
| Ex. 34 | 90 | 870.1 | 40.1 |
| Ex. 35 | 170.1 | 790 | 40.1 |

### Examples 36-38

In Examples 36-38, the hard fat and liquid oil were formulated before addition of cellulose fiber as follows. In a 2500 mL beaker, the desired quantity of liquid oil was weighed. The beaker was placed on a hotplate and an agitator was positioned. The agitator was turned on and speed was set at 300 RPM. The hot plate was turned to 200° C. The desired quantity of hard fat was added and stirring continued till temperature reached 70° C. The desired quantity of cellulose was added while mixing. The mixing was continued for about 5 minutes. The agitator speed was 300 RPM. The heat and agitation were turned off after 5 minutes. The compositions were cooled as described in Examples 1-4.

The mixture was cooled to 70° C. and then crystallized in an ice cream maker.

| | Hard Fat | | | | |
|---|---|---|---|---|---|
| | Hard Fat Blend | Soya | Palm | | |
| | (PHF 77.5% + | hard fat | hard fat | Canola | Cellulose Fiber |
| Ex. | SHF 22.5%) (g) | (g) | (g) | oil (g) | 900 FCC (g) |
| 36 | 107.5 | | | 852.5 | 40 |
| 37 | 120 | | | 840 | 40 |
| 38 | 120 | | | 840 | 40 |

### Examples 39-40

In Examples 39-40, palm stearin was used as the hard fat and higher loading of cellulose fiber was used. The formulations were stirred in small amounts in the ice cream maker inside a walk-in freezer at −20° C.

| | Palm | Canola | Cellulose Fiber |
|---|---|---|---|
| Ex. | stearin (g) | oil (g) | (900 FCC) (g) |
| 39 | 230 | 690 | 80 |
| 40 | 210 | 710 | 80 |

### Example 41

A structuring blend of triglycerides, diglycerides, monoglycerides produced from soybean oil then hydrogenated to saturation was used as the structuring fat.

| | Structuring | Canola | Cellulose Fiber |
|---|---|---|---|
| Ex. | blend (g) | oil (g) | (900 FCC) (g) |
| 41 | 120 | 840 | 40 |

This example demonstrates that components other than saturated triglycerides could be used to structure along with the cellulose fibers.

### Examples 42-45

In Examples 42-45, various cellulose fibers were used to study their effect on the formulation.

| | | |
|---|---|---|
| Hard fat | Canola | Cellulose Fiber (g) |

| Ex. | blend (g) | oil (g) | 900 FCC | 40 FCC | 150 QC |
|---|---|---|---|---|---|
| 42 | 107.5 | 853.5 | 20 | 20 | |
| 43 | 107.5 | 852.50 | | | 40 |
| 44 | 107.5 | 852.5 | 20 | | 20 |
| 45 | 107.5 | 852.5 | | 20 | 20 |

### Example 46

A small amount of water was added to see if it helped in structuring the formulation.

| | Hard fat | Canola | Cellulose Fiber | Water |
|---|---|---|---|---|
| Ex. | blend (g) | oil (g) | (900 FCC) (g) | (g) |
| 46 | 107.5 | 851.5 | 40 | 1 |

At this level of addition, the shortening was not noticeably different from that prepared without any water.

### Example 47

A small amount of glycerin was added to see if it helped in structuring the formulation.

| | Hard fat | Canola | Cellulose Fiber | |
|---|---|---|---|---|
| Ex. | blend (g) | oil (g) | (900 FCC) (g) | Glycerin (g) |
| 47 | 107.5 | 851.5 | 40 | 1.02 |

At this level of addition, the shortening was not noticeably different from that prepared without any glycerin.

### Example 48-50

In Examples 48-50, partially hydrogenated base oil was used in the formulations.

| | | Partially | |
|---|---|---|---|
| | Hard fat | hydrogenated | Cellulose Fiber |
| Ex. | blend (g) | base oil (g) | (900 FCC) (g) |
| 48 | 107.50 | 852.51 | 40 |
| 49 | 87.50 | 872.50 | 40 |
| 50 | 67.50 | 892.50 | 40 |

### Examples 51-54

In Examples 51-54, an emulsifier was used for shortening formulation for cake and icing work.

| | | | | Monoglyceride | Polyglycerol |
|---|---|---|---|---|---|
| | | | | DIMODAN P-T- | ester |
| | | | Cellulose | K-A Distilled | POLYALDO |
| | Hard fat | Canola | Fiber (900 | Monoglyceride | TGMSH-K |
| Ex. | blend (g) | oil (g) | FCC) (g) | (DANISCO) (g) | (LONZA) (g) |
| 51 | 107.50 | 836 | 40 | 7.50 | 9 |
| 52 | 107.50 | 833.50 | 40 | 10 | 9 |
| 53 | 107.50 | 833.50 | 40 | 7.50 | 11.50 |
| 54 | 107.50 | 822.50 | 40 | 14 | 16.01 |

### Example 55

A pilot plant run was conducted using the following ingredients:

| | Palm Hard | Soya Hard | QC 150 | High Oleic |
|---|---|---|---|---|
| Ex. | Fat (%) | Fat (%) | CreaFibe (%) | Canola (%) |
| 55 | 8.3313 | 2.4187 | 4.5000 | 84.7500 |

A batch of 200 lbs was started. The composition was formulated by mixing HOC, hard fat blend and cellulose. The complete blend was re-circulated through pump and static mixer for 30 minutes before going to the cooling units. Static mixers were added to re-circulate the blend to help disperse cellulose fiber before going to cooling units.

Line configuration: A-C-B-fill

A and C units are cooling units, the B unit is a working unit with pins on a rotor and pins projecting from cylinder wall.

| | |
|---|---|
| Condition one | Condition one |
| target | actual |

| Feed tank temp | 129 | F. | 130 | F. |
|---|---|---|---|---|
| Feed pump setting | 1 | | 1 | |
| Temp A outlet | 78 | F. | 78 | F. |
| Temp B outlet | 68 | F. | 67 | F. |
| Temp C outlet | 66 | F. | 66 | F. |

varidrive setting on cooling unit shafts

| | | |
|---|---|---|
| A unit | 7 | 7 |
| B unit | 3 | 3 |
| C unit | 7 | 7 |

Back pressure 6 PSIG, Ammonia setting A 60, C 55 nitrogen enough to make product white.
The product was fluid going into box as a self leveling white liquid. It took 2.4 minutes to fill 10 lb.

| | |
|---|---|
| Condition two | Condition two |
| target | actual |

| Feed tank temp | 130 | F. | 131 | F. |
|---|---|---|---|---|
| Feed pump setting | 1 | | 1 | |
| Temp A outlet | 77-78 | F. | 78 | F. |
| Temp B outlet | 68 | F. | 69 | F. |
| Temp C outlet | 66 | F. | 66 | F. |

varidrive setting on cooling unit shafts

| | | |
|---|---|---|
| A unit | 7 | 7 |
| B unit | 5 | 5 |
| C unit | 7 | 7 |

Back pressure 8 PSIG Ammonia setting A 45 C 50 nitrogen enough to make product white.
The product was fluid going into the box as a self leveling white liquid. It took 2.4 minutes to fill 10-lb.

| | |
|---|---|
| Condition three | Condition three |
| target | actual |

| Feed tank temp | 128 | F. | 130 | F. |
|---|---|---|---|---|
| Feed pump setting | 1 | | 1 | |
| Temp A outlet | 78 | F. | 78 | F. |
| Temp B outlet | 65 | F. | 65 | F. |
| Temp C outlet | 63 | F. | 63 | F. |

varidrive setting on cooling unit shafts

| | | |
|---|---|---|
| A unit | 7 | 7 |
| B unit | 5 | 5 |
| C unit | 7 | 7 |

Back pressure 10 PSIG Ammonia setting A 40 C 45 nitrogen enough to make product white.
The product was fluid going into the box as a self leveling white liquid. It took 2.4 minutes to fill 10-lb.

### Example 56

A pilot plant run for cake and icing shortening was conducted using the following ingredients:

| | | | | | Monoglyceride |
|---|---|---|---|---|---|
| | | | | | DIMODAN P-T- |
| | | | QC 150 | | K-A Distilled |
| | Palm Hard | Soya Hard | CreaFibe | High Oleic | Monoglyceride |
| Ex. | Fat (%) | Fat (%) | (%) | Canola (%) | (DANISCO) (g) |
| 56 | 8.0814 | 2.3461 | 4.3650 | 82.2075 | 3.000 |

A batch of 200 lbs was started. The composition was formulated by mixing HOC, hard fat blend and cellulose. The complete blend was re-circulated through pump and static mixer for 30 minutes before going to the cooling units. Static mixers were added to re-circulate the blend to help disperse cellulose fiber before going to cooling units.

Line configuration: A-C-B-fill

| | |
|---|---|
| Condition one | Condition one |
| target | actual |

| Feed tank temp | 129 | F. | 131 | F. |
|---|---|---|---|---|
| Feed pump setting | 1 | | 1 | |
| Temp A outlet | 78 | F. | 78 | F. |
| Temp B outlet | 68 | F. | 68-69 | F. |
| Temp C outlet | 66 | F. | 66 | F. |

varidrive setting on cooling unit shafts

| | | |
|---|---|---|
| A unit | 7 | 7 |
| B unit | 3 | 3 |
| C unit | 7 | 7 |

Back pressure 14-12 PSIG, Ammonia setting A 35, C 50 nitrogen enough to make product white.
The product was fluid going into box as a self leveling white liquid. It took 2.4 minutes to fill 10 lb.

| | |
|---|---|
| Condition two | Condition two |
| target | actual |

| Feed tank temp | 130 | F. | 131 | F. |
|---|---|---|---|---|
| Feed pump setting | 1 | | 1 | |
| Temp A outlet | 77-78 | F. | 78 | F. |
| Temp B outlet | 68 | F. | 68 | F. |
| Temp C outlet | 66 | F. | 66 | F. |

varidrive setting on cooling unit shafts

| | | |
|---|---|---|
| A unit | 7 | 7 |
| B unit | 5 | 5 |
| C unit | 7 | 7 |

Back pressure 8 PSIG Ammonia setting A 45 C 50 nitrogen enough to make product white.
The product was fluid going into the box as a self leveling white liquid. It took 2.4 minutes to fill 10-lb.

| | |
|---|---|
| Condition three | Condition three |
| target | actual |

| Feed tank temp | 128 | F. | 132 | F. |
|---|---|---|---|---|
| Feed pump setting | 1 | | 1 | |
| Temp A outlet | 78 | F. | 78-77 | F. |
| Temp B outlet | 65 | F. | 66-65 | F. |
| Temp C outlet | 63 | F. | 63-62 | F. |

varidrive setting on cooling unit shafts

| | | |
|---|---|---|
| A unit | 7 | 7 |
| B unit | 5 | 5 |
| C unit | 7 | 7 |

Back pressure 10 PSIG Ammonia setting A 40 C 45 nitrogen enough to make product white.
The product was fluid going into the box as a self leveling white liquid. It took 2.4 minutes to fill 10-lb.

### Example 57

A pilot plant all purpose shortening was conducted using the following ingredients:

| | Palm Hard | Soya Hard | QC 150 | Canola |
|---|---|---|---|---|
| Ex. | Fat (%) | Fat (%) | CreaFibe (%) | Oil (%) |
| 57 | 8.3313 | 2.4187 | 4.5000 | 84.7500 |

A batch of 150 lbs was started. The composition was formulated by mixing HOC, hard fat blend and cellulose. The complete blend was re-circulated through pump and static mixer for 30 minutes before going to the cooling units. Static mixers were added to re-circulate the blend to help disperse cellulose fiber before going to cooling units.

Line configuration: A-C-B-fill

| | |
|---|---|
| Condition one | Condition one |
| target | actual |

| Feed tank temp | 120-130 | F. | 129 | F. |
|---|---|---|---|---|
| Feed pump setting | 1 | | 1 | |
| Temp A outlet | 80 | F. | 78 | F. |
| Temp B outlet | | | 68 | F. |
| Temp C outlet | 70 | F. | 66 | F. |

varidrive setting on cooling unit shafts

| | | |
|---|---|---|
| A unit | 7 | 7 |
| B unit | 5 | 3 |
| C unit | 7 | 7 |

Back pressure 10 PSIG, Ammonia setting A 50, C 50 nitrogen enough to make product white.
The product was fluid going into box as a self leveling white liquid. It took 2.4 minutes to fill 10 lb.

| | |
|---|---|
| Condition two | Condition two |
| target | actual |

| Feed tank temp | 125-130 | F. | 130 | F. |
|---|---|---|---|---|
| Feed pump setting | 1 | | 1 | |
| Temp A outlet | 75 | F. | 78-77 | F. |
| Temp B outlet | 68 | F. | 68 | F. |
| Temp C outlet | 66 | F. | 66 | F. |

varidrive setting on cooling unit shafts

| | | |
|---|---|---|
| A unit | 7 | 7 |
| B unit | 5 | 5 |
| C unit | 7 | 7 |

Back pressure 10 PSIG Ammonia setting A 50 C 50 nitrogen enough to make product white.
The product was fluid going into the box as a self leveling white liquid. It took 2.4 minutes to fill 10-lb.

| | |
|---|---|
| Condition three | Condition three |
| target | actual |

| Feed tank temp | 125-130 | F. | 128 | F. |
|---|---|---|---|---|
| Feed pump setting | 1 | | 1 | |
| Temp A outlet | 78 | F. | 78 | F. |
| Temp B outlet | | | 65 | F. |
| Temp C outlet | 63 | F. | 63 | F. |

varidrive setting on cooling unit shafts

| | | |
|---|---|---|
| A unit | 7 | 7 |
| B unit | 5 | 5 |
| C unit | 7 | 7 |

Back pressure 8 PSIG Ammonia setting A 55 C 40 nitrogen enough to make product white.
The product was fluid going into the box as a self leveling white liquid. It took 2.4 minutes to fill 10-lb.

The all purpose shortening and cake and icing shortening samples prepared in Examples 55 and 56 were stored for 72 hours at 70° F. and then inspected. All samples were soft plastic shortenings. A cube of each set was returned to 70° F. storage and a cube of each set was moved to an 85° F. controlled temperature room to simulate transport during warmer months. After eighth days, the cubes stored at 85° F. were examined. No oiling out was observed. About half the material was scooped into a new bag and box and returned to storage at 85° F. The other half was moved back to storage at 70° F. The oil stored for the whole time at 70° F. was application tested. The oil stored for 72 hours at 70° F. taken to 85° F. for eight days and brought back to 70° F. was evaluated in certain applications. The oil held at 70° F. moved and held at 85° F. was evaluated in certain applications. The oil held 70° F. performed well, the oil moved to 85° F. and returned to 70° F. performed well. The oil moved to 85° F. and kept at 85° F. in the case of the cake and icing formulation made a cake but not an icing.

The cake and icing formulation did not work in a pound cake formulation.

The shortening compositions described above were tested in various bakery applications. In application in cookies, it appeared that there was a relation between fiber content in the shortening compositions and spread during baking As the fiber content increased spread decreased.

In pie crust testing, the fiber containing shortenings made a less flake crust but one that shrank less and had a higher weight after baking

Small chocolate chips (4000 count chips per lb) were more visible in baked cookies that used fiber containing shortenings. As chip size or inclusion size increased this characteristic of appearing more visible rapidly declined to essential equality.

Of the emulsified shortenings, shortenings of Examples 53 and 55 had the best overall performance.

The shortenings were also tested in rolled sugar cookies with success.

### Example 58

Two all purpose shortening formulations were prepared using analogous procedures to those described in Examples 55-57 above.

The following ingredients were used:

| | Palm Hard | Soya Hard Fat | QC 150 | |
|---|---|---|---|---|
| Formulation | Fat (IV < 5) | (IV < 5) | CreaFibe | Canola |
| No. | (%) | (%) | (%) | Oil (%) |
| 1 | 7.21 | 2.09 | 4.50 | 86.20 |
| 2 | 10.96 | 3.18 | 4.50 | 85.76 |

Formulation 1 had about 14.96% saturate level and Formulation 2 had about 19% saturate level. Formulation 2 also contained about 200 ppm of antioxidant TBHQ (0.1% of the 20% TBHQ in vegetable oil carrier). The above shortening formulations were analyzed for Mettler Dropping Point, solid fat content (SFC) profile at various temperatures, % saturates and % trans fats using routine procedures.

The table below provides analytical values for all purpose shortening Formulation 1:

| Test | Analytical Value |
|---|---|
| Mettler Dropping Point | 114.1° F. |
| SFC@ 50° F. | 11.56 |
| SFC@ 70° F. | 8.15 |
| SFC@ 80° F. | 7.99 |
| SFC@ 92° F. | 7.26 |
| SFC@ 104° F. | 5.38 |
| % Saturates | 14.96 |
| % trans | <1.00 |

The table below provides analytical values for the all purpose shortening Formulation 2 at about 19% saturates formulation :

| Test | Analytical Value |
|---|---|
| Mettler Dropping Point | 118.8° F. |
| SFC@ 50° F. | 15.77 |
| SFC@ 70° F. | 13.98 |
| SFC@ 80° F. | 12.30 |
| SFC@ 92° F. | 10.46 |
| SFC@ 104° F. | 6.62 |
| % Saturates | 19.50 |
| % trans | <1.00 |

### Example 59

A cake and icing shortening formulation was prepared using analogous procedures to those described in Examples 55-57 above.

The following ingredients were used:

| | Palm | Soya | | | Distilled | | Antioxidant 20 |
|---|---|---|---|---|---|---|---|
| Formulation | Hard Fat | Hard Fat | QC 150 | Canola | mono from | PGE | TBHQ (Tertiary |
| No. | (IV < 5) | (IV < 5) | CreaFibe | Oil | palm | TGMSH-K | Butyl Hydroquinone) |
| 1 | 7.21% | 2.09% | 4.50% | 84.20% | 0.75% | 1.15% | 0.10% |
| 2 | 10.25% | 2.98% | 4.50% | 80.27% | 0.75% | 1.15% | 0.10% |

Antioxidant TBHQ was added as 20% TBHQ in vegetable oil carrier).

The above cake and icing shortening formulation was analyzed for Mettler Dropping Point, solid fat content (SFC) profile at various temperatures, % saturates and % trans fats using routine procedures were determined on the oil phase.

The all purpose and cake and icing shortening formulations described in Examples 58 and 59 were tested in various bakery applications, including chocolate chip cookies, pie crust, for the all purpose shortenings and layer cake, icing, and pound cake formulations for the cake and icing formulations. Both the formulations produced acceptable products.

### Example 60

A bag of Kroger Microwave Popcorn, (Movie Theater Butter Brand, a serving size of 33 g un-popped with about 3 serving per bag) was opened and all of the corn and most of the shortening and salt was placed on a Buchner funnel. The Buchner funnel was placed in an oven to melt the fat away from the corn. The corn was wiped and blotted off with paper towels to remove most of the fat. The corn weighted 70.73 g. The three main ingredients of the bag were:

70.73 g corn

2.67 g salt

25.60 g shortening

90.6 g of shortening of Example 59 was mixed with 9.47 g of Morton brand popcorn salt. The shortening was spread on a foil to about ½ inch thick, salt was sprinkled on it, and then mixed with a spatula. 28.27 g of this shortening and salt mixture was mixed in 70.7 g of popcorn.

Another bag of Kroger Microwave Popcorn was popped and the top side at the end of the bag was opened to remove the corn and shortening. The popcorn mixture prepared above in paragraph [0094] was added to the empty bag, the bag was sealed with white scotch brand duct tape, placed in a microwave oven orienting the bag according to the instructions. During popping of the popcorn, the was bag opened at the cut and popped and un-popped corn was expelled from the bag. The popped corn was taste tested. It was observed that the cellulose from the shortening did not impact the taste or month feel of the popped corn.

The experiment was repeated with another bag of popcorn. This time, about a 1½ inch band from the popcorn bag was cut off. The contents of the bag were emptied, the mixture prepared above in paragraph [0094] was added to the empty bag. The band was placed over the slit in the bag and taped into place with the white duct tape. This set up contained the popcorn during popping.

The mixture was popped in a microwave oven using GE Profile 2.2 Cu. Ft. Countertop Microwave Oven following the pop corn setting.

### Example 61

Empty bags for popping microwave popcorn were purchased from SNAPPY® POPCORN Co., Inc. and similar experiments as described in example 60 were conducted using these bags. Orvillie Redenbacher's Original popcorn was used for this study. 99 g (+/−0.5 g) of popcorn mixture prepared above in paragraph [0094] was weighted into a plastic cup and then transferred to an empty bag. After placing the popcorn mixture into the bag the mixture was flattened by pressing down on the outside of the bag with the palm of the hand. Thirty five bags were filled in this manner. The bags were sealed using an impulse sealer (Midwest Pacific Impulse Sealer Model MP-12).

Each bag contained an average of 440 corn kernels. Three bags were popped one at a time using a Magic Chef Microwave (oven model MCB110B) oven's popcorn setting. The popped popcorn from 2 bags were distributed for tasting. It was determined that taste was acceptable and the presence of the cellulose caused no major problem with the acceptability of the popped product.

The third bag was popped and the un-popped kernels counted (48 un-popped).

30 empty popcorn bags were filled as described above, and placed onto 6 full sheet pans lined with parchment paper such that there were five bags per sheet pan. A set of 2 of these sheet pans was placed in 70° F. room for storage, another set of two pans was stored in an 85° F. room, and the third set was stored in a 100° F. room. After three weeks of storage, no wicking of oil was seen on any of the bags in storage.

Another batch of popcorn, shortening, and salt mixture was prepared as described in paragraph [0094]. Two bags were filled as described above, popped, and the un-popped kernels were counted. The two bags contained 49 and 22 un-popped kernels.

Three 15 cm Buchner funnels were set with a filter paper (Whatman 4 Qualitative Circles 150 mm Cat No 1004 150). Each piece of filter paper and each funnel were weighed. A four inch cookie cutter ring was placed at the center of each funnel. About 80g (80.2 g, 80.5 g, 80.4 g) of the popcorn mixture in paragraph [00102] was placed in the ring and pressed down with a spatula into a uniformly thick 4 inch diameter mass on the paper. The ring was then removed. The funnels were placed in a 100° F. room for 24 hours. A weighted receiving beaker was placed below each funnel. After 24 hours, no oil was observed in any of the receiving beakers. The mass of popcorn and oil was still held together by a plastic matrix of shortening in the shape of the ring at the end of 24 hours. Oil had wicked to the edge of each filter paper and some liquid oil was seen on the surface of the filter when the paper was removed. The popcorn mass was scrapped off the filter paper and the paper weighted for each of the three set ups. The papers gained 1.88 g, 1.91 g, and 2.17 g of oil weight. The funnels gained 0.08 g, 0.06 g and 0.05 g of weight, respectively.

The order and manner of mixing the popcorn, salt and shortening together are not thought to be critical for microwave popcorn products. In certain embodiment, various flavors are added to the popcorn mixture. In certain embodiments, the popcorn and salt are added to an empty bag, and then the shortening is pumped in. The mixture can be roughly mixed by applying pressure.

### Example 62

In this experiment, a microscopic evaluation of deposited shortening in low, moderate and heavy matrix was conducted to study distribution of fiber and salt in the microwave popcorn. Empty popcorn bags were filled with popcorn. The shortening system, i.e., shortening and salt mixture was added to each bag at about 110° F.-135° F. The shortening and salt mixture was added in three settings: low shortening system setting wherein the amount of shortening system added was about 2.5-3.5 weight % based on weight of the total contents of the bag, moderate shortening system setting wherein the amount of shortening system added was about 10-15 weight % based on weight of the total contents of the bag, and high shortening system setting wherein the amount of shortening system added was about 30-35 weight % based on weight of the total contents of the bag.

After cooling the contents of the popcorn bags to room temperature, shortening samples were collected from four different sites from a microwave popcorn sample bag. Each sample was about 5 μL. Each sample aliquot was placed on a microscope slide and was covered with slide cover before microscopic evaluation. The microscopic evaluation was conducted at 100× magnification under a polarized light microscope.

Low shortening system matrix: The fibers present had different diameters and a tendency to form conglomerates.

Moderate shortening system matrix: The salt was distributed uniformly. The fibers present had different diameters and a tendency to form conglomerates.

High shortening system matrix: The salt was distributed uniformly. The diameter of the fibers was uniform and smaller compared with the low and moderate shortening system samples. A better distribution of the fiber than the low and moderate shortening system samples was observed.

The compositions provided herein provide a uniform distribution of salt and shortening.

### Example 63

A comparative study with shortening compositions was conducted to obtain a composition having a balance of low saturate level and acceptable storage capacity when used in popcorn bags. The following compositions were tested:
1) shortening compositions containing canola oil and a blend of hard fats,
2) shortening compositions containing canola oil, a blend of hard fats, and a cellulose fiber, and
3) shortening compositions containing canola oil and a cellulose fiber.

Compositions Containing Canola Oil and a Blend of Hard Fats

Shortening compositions containing canola oil and a hard fat blend were prepared to achieve target percentage of saturated fatty acids ranging from 16% to 23% in 1% increments. The table below provides amounts of canola oil, hard fat, the targeted amount of saturates and actual amount of saturates. The hard fat blend contained fully hydrogenated palm oil (77.5%) plus fully hydrogenated soybean oil (22.5%). These blends were also analyzed using AOCS method Ce 1f-96(02).

TABLE

| Canola Oil | Hard fat Blend | % Sat. (Theoretical | % Sat. (Analytical |
|---|---|---|---|
| (grams) | (grams) | Value) | Value by FAME |
| 464.4 | 47.7 | 16 | 15.95 |
| 458.9 | 53.1 | 17 | 16.76 |
| 453.8 | 58.6 | 18 | 17.75 |
| 447.8 | 64.2 | 19 | 18.71 |
| 442.3 | 69.7 | 20 | 19.70 |
| 436.8 | 75.2 | 21 | 20.71 |
| 431.3 | 80.7 | 22 | 21.64 |
| 425.7 | 86.3 | 23 | 22.86 |

The hard fat fractions (fully hydrogenated Palm oil and fully hydrogenated soybean oil) were melted and mixed together and poured out into full cake sheet pans to solidify into a slab about ½ inch thick. This slab was broken into small pieces to use as a hard fat potion of the final compositions. These compositions were prepared in laboratory using 1,000 ml beaker with an appropriate ratio between liquid canola oil and hard fat blend.

The beaker with liquid canola oil portion of the composition was heated in a microwave such that the oil temperature reached at least 165° F. The hot oil and hard fat chunks were stirred until the hard fat melted and mixed into solution. The beaker was then placed on a hot plate and stirred at about 400 RPM using a Heidolph RZR 2020 mixer. Morton Extra Fine 325 Salt (Morton International Inc.) (53.4 g) was added to the agitated oil and mixed to form a uniform suspension. When the slurry temperature dropped to 130 to 138° F., the hot plate was turned down, and a portion of this slurry was drawn into a 60 ml plastic syringe (BD 60 ml syringe Becton Dickinson and company) from which 28.3 g (+/−1 g) was delivered on top of 71 g of popcorn (+/−0.5 g) previously pre-weighed into a microwave popcorn bag. The popcorn bag had about the bottom third folded up and was placed into the side of a test tube rack which acted as a holder for weighting in the popcorn and as a holder for weighting the bag and contents as the slurry was delivered by the syringe. The bag was then sealed and the top third of the bag was folded over the popcorn and slurry charge. These charged popcorn bags were packed into a plastic sandwich bag. Ten bags for each composition were placed on a full cake pan and after setting up at room temperature (69-73° F.) for at least an hour, the bags were moved to a 100° F. room for storage.

Following 16 days of storage at 100° F., the pop corn bags were examined for oil staining The bags containing 20.71%, 21.64% and 22.86% saturates had no oil stained bags which showed that the hard fat blend could stabilize the liquid oil and prevent wicking into the bag during the 16 days stress test. The bags containing saturates at 15.95%, 16.76%, 17.75%, 18.71% and 19.70% showed oil staining in some bags. The table below summarized the bag staining observations in each compositions:

| % Saturate | No. of bags with oil stain |
|---|---|
| 15.95 | 3 |
| 16.76 | 3 |
| 17.75 | 4 |
| 18.71 | 3 |
| 19.70 | 2 |
| 20.71 | None |
| 21.64 | None |
| 22.86 | None |

Some variability in results could be expected depending on how the bags are folded, how the delivery of the slurry is charged into the bags, and other factors.

Compositions Containing Canola Oil, a Blend of Hard Fats, and a Cellulose Fiber

Shortening compositions containing canola oil and a hard fat blend were prepared to achieve target percentage of saturated fatty acids of 16%, 17% and 18%. The table below provides amounts of canola oil, hard fat, the targeted amount of saturates and actual amount of saturates in the compositions. The hard fat blend contained fully hydrogenated palm oil (77.5%) plus fully hydrogenated soybean oil (22.5%). These blends were also analyzed using AOCS method Ce 1f-96(02).

| Canola Oil | Hard fat Blend | % Sat. (Target | % Sat. (Analytical |
|---|---|---|---|
| (grams) | (grams) | amount) | amount by FAME |
| 464.4 | 47.6 | 16 | 15.78 |
| 458.9 | 53.1 | 17 | 16.73 |
| 453.8 | 58.6 | 18 | 17.78 |

53.4 g Morton Extra Fine 325 salt (Morton International Inc.) and 25.6 g of JustFiber C40 FCC grade cellulose from International Fiber Corporation was added to each composition. The mixture was agitated for at least 20 minutes at 400 RPM. Each composition was tested in 10 microwave popcorn bags. The compositions containing about 16% saturates were filled (29.6 g+/−1 g) without difficulty using a 60 ml syringe. The compositions containing about 17% and 18% saturates had some cellulose clumps that blocked the syringe. These compositions were sheared with a Silverson L4RT mixer at 1,000 RPM using the Emuilsor Screen for about 1 minute and returned to the hot plate. The lumps were dispersed and the slurry addition to the bags proceeded without further difficulty. Photomicrographs that were taken after the storage test showed this treatment had no gross effect on the fibers.

Following 16 days of storage of 10 microwave popcorn bags for each composition at 100° F., three out of ten bags showed oil staining from the 15.78% treatment. There was no oil staining on any of the storage bags from the 16.73% and 17.78% treatments. The observations are summarized below:

| % Saturate | No. of bags with oil stain |
|---|---|
| 15.78 | 3 |
| 16.73 | None |
| 17.78 | None |

Some variability in results could be expected depending on how the bags are folded, how the delivery of the slurry is charged into the bags, and other factors.

Compositions Containing Canola Oil and a Cellulose Fiber

Compositions containing cellulose fiber alone with canola oil were prepared. The cellulose fiber was added at 20% the weight of the oil used. The mixture was blended on the hot plate and held at 130 to 138° F. The agitator was set initially at 2,000 RPM, and then speed was reduced to about 1,000 RPM as composition was used to fill the microwave popcorn bags. As described above, 10 bags were filed. The compositions were added to deliver about 25.6 g of oil to each bag tested. The additional mass included salt and cellulose added to the mixture.

The composition was a crumbly semisolid which was spooned from the beaker and into the popcorn in the bags (32.4 g+/−1 g). The bags had to be tapped to distribute the mixture into the corn. Following 16 days storage at 100° F., 7 of the 10 bags showed some oil staining Popping one bag following the storage tested showed that most of the fiber stayed in clumps unevenly distributed among the popped corn.

Conclusion

The results from the three experiments demonstrated that the combination blend of fully hydrogenated palm and soybean oil used with the fibers allows a lower saturate containing shortening to produce an acceptable storage test than the use of either the hard fat system or cellulose fibers alone.

### Example 64

Additional fibers were evaluated on a bench scale using JUSTFIBER® C40 FCC and RIDGELAND® Fiber PC-200 cellulose fibers. The average fiber length of RIDGELAND® Fiber PC-200 was 300 microns, and for JUSTFIBER® C40 FCC.

The shortening compositions were prepared using procedures similar to those described above in Examples 1-55. The compositions contained 86.20% canola oil, 9.3% hard fat blend (fully hydrogenated palm oil (77.5%) plus 22.5% fully hydrogenated soybean oil and 4.5% of cellulose fibers.

Two control batches were prepared using Creafil QC 150 (average fiber length 115 microns) and Creafil SC 150 (average fiber length 120 microns) cellulose fibers as standards. These shortening compositions were evaluated in the chocolate chip cookie formulation. The cookies made with Creafil QC 150 and Creafil SC 150 shortening compositions were virtually identical, while cookies made with JUSTFIBER® C40 FCC and RIDGELAND® Fiber PC-200 were likewise virtually identical but showed a little less spread and a little greater post baking weight than the control cookies.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A shortening composition comprising an admixture of a cellulose fiber, a hard fat, and a liquid oil, wherein the shortening composition comprises less than about 1% water by weight based on total weight of the composition.

2. The shortening composition of claim 1, wherein the cellulose fiber is from a plant source.

3. The shortening composition of claim 1, wherein the cellulose fiber comprises cellulose fiber from wood pulp, bamboo, pea, citrus fruit or sugar beet.

4. The shortening composition of claim 1, wherein the cellulose fiber is present in an amount from about 1 to 15% by weight based on the total weight of the composition.

5. The shortening composition of claim 1, wherein the amount of cellulose fiber is from about 3 to 10% by weight based on the total weight of the composition.

6. The shortening composition of claim 1, wherein the amount of cellulose fiber is from about 3 to 6% by weight based on the total weight of the composition.

7. The shortening composition of claim 1, wherein the hard fat comprises a fully or partially hydrogenated oil, solid stearin fraction, diglyceride, monoglyceride, wax or a mixture thereof.

8. The shortening composition of claim 7, wherein the fully hydrogenated oil is selected from fully hardened fish oil, fully hardened animal oil, fully hardened palm oil, fully hardened high erucic rape seed oil, fully hardened soya oil, fully hardened sun flower oil, fully hardened corn oil, fully hardened peanut oil, fully hardened safflower oil, fully hardened olive oil, fully hardened palm stearin, fully hardened palm olein, a derivative and mixture thereof.

9. The shortening composition of claim 7, wherein the partially hydrogenated oil is selected from partly hardened fish oil, partly hardened animal oil, partly hardened palm oil, partly hardened high erucic rape seed oil, partly hardened soya oil, partly hardened sun flower oil, partly hardened corn oil, partly hardened peanut oil, partly hardened safflower oil, partly hardened olive oil, partly hardened palm stearin, partly hardened palm olein, partly hardened cotton seed oil, a derivative and mixture thereof.

10. The shortening composition of claim 1, wherein the hard fat is selected from palm hard fat, soybean oil hard fat, cotton hard fat, palm stearin and a mixture thereof.

11. The shortening composition of claim 1, wherein the hard fat is a blend of palm hard fat and soybean oil hard fat.

12. The shortening composition of claim 1, wherein the hard fat is present in an amount from about 5 to about 20% by weight based on total weight of the composition.

13. The shortening composition of claim 1, wherein the hard fat is present in an amount from about 8 to about 15% by weight based on total weight of the composition.

14. The shortening composition of claim 1, wherein the liquid oil comprises canola, high oleic canola, soybean, corn, sunflower, rapeseed, peanut, safflower, olive, cottonseed, or a mixture thereof.

15. The shortening composition of claim 1, wherein the liquid oil is present in an amount from about 75 to about 90% by weight based on total weight of the composition.

16. The shortening composition of claim 1 comprising about 4.5% cellulose fiber, about 8.3% palm hard fat, about 2.4% soybean hard fat and about 84.8% high oleic canola oil by weight based on the total weight of the composition.

17. The shortening composition of claim 1 comprising about 4.4% cellulose fiber, about 8.1% palm hard fat, about 2.4% soybean hard fat and about 82.2% canola oil by weight based on the total weight of the composition and about 3 g monoglyceride from palm oil.

18. The shortening composition of claim 1 comprising about 4.5% cellulose fiber, about 8.3% palm hard fat, about 2.4% soybean hard fat and about 84.8% canola oil by weight based on the total weight of the composition.

19. The shortening composition of claim 1 comprising about 4.5% cellulose fiber, about 7.21% palm hard fat, about 2.09% soybean hard fat and about 86.20% canola oil by weight based on the total weight of the composition.

20. The shortening composition of claim 1 comprising about 4.5% cellulose fiber, about 7.2% palm hard fat, about 2.1% soybean hard fat, about 84.2% canola oil, about 0.8% distilled monoglyceride from palm oil, about 1.2% PGE TGMSH-K, and about 0.1% antioxidant by weight based on the total weight of the composition.

21. A food product comprising the shortening composition of claim 1.

22. The food product of claim 21 selected from popcorn, cake, cookie, pie crust or biscuit.

23. A method of preparing a shortening, the method comprising the steps of
providing a composition comprising a cellulose fiber, a hard fat fraction, and a liquid oil, wherein the composition comprises less than about 1% water based on the total weight of the composition, and
mixing the composition to provide a shortening composition.

24. The method of claim 23, wherein the cellulose fiber and the liquid oil are blended prior to addition of the hard fat.

25. The method of claim 23, wherein the hard fat and the liquid oil are blended prior to addition of the cellulose fiber.

26. The method of claim 23, wherein the composition is heated during the mixing step to a temperature of about 45° C. to about 90° C.

27. The method of claim 26 comprising a further step of cooling the mixed composition.

28. The method of claim 27, wherein the step of cooling is performed in a heat exchanger.

29. The method of claim 28, wherein the heat exchanger is a scraped surface heat exchanger.
